(19) United States
(12) Patent Application Publication
(10) Pub. No.: US 2023/0169360 A1
(43) Pub. Date: Jun. 1, 2023

(54) GENERATING ONTOLOGIES FROM PROGRAMMATIC SPECIFICATIONS

(71) Applicant: Accenture Global Solutions Limited, Dublin (IE)

(72) Inventors: Nimrod Busany, Tel Aviv (IL); Gal Engelberg, Pardes-hana (IL); Dan Klein, Rosh Ha'ayin (IL); Tomer Ram, Netanya (IL)

(21) Appl. No.: 18/070,764

(22) Filed: Nov. 29, 2022

Related U.S. Application Data
(60) Provisional application No. 63/283,702, filed on Nov. 29, 2021.
(60) Provisional application No. 63/285,193, filed on Dec. 2, 2021.

(51) Int. Cl. G06N 5/022; G06F 16/21

(52) U.S. Cl. CPC G06N 5/022; G06F 16/212

(57) ABSTRACT

Implementations include methods, systems, computer-readable storage medium for generating ontologies from programmatic specifications. A method includes receiving data indicating a configuration for a data crawler; extracting, by the data crawler, representations of a subset of programmatic specifications; generating a knowledge graph model of the subset of the programmatic specifications; refining the knowledge graph model by classifying nodes in the knowledge graph model to obtain a refined knowledge graph model; and generating an ontology from the refined knowledge graph model. Refining the knowledge graph model comprises: iteratively classifying nodes of the knowledge graph model and refining the knowledge graph model based on the classifications of the nodes to obtain the refined knowledge graph model. the programmatic specifications include application programming interface specifications or databases of tables.

### CROSS-REFERENCE TO RELATED APPLICATIONS

This application claims priority to U.S. 63/285,193, filed on Dec. 2, 2021, and U.S. 63/283,702, filed Nov. 29, 2021, the disclosures of which are expressly incorporated herein by reference in the entirety.

### FIELD

This specification relates to systems for generating ontologies from programmatic specifications.

### BACKGROUND

Service providers expose their services to clients via application programming interfaces (APIs). These come in different forms such as command line interface (CLI), representational state transfer (REST), and other forms. APIs are often documented in specifications files written according to community standards. For example, Swagger/OpenAPI are example specifications for documenting REST APIs that are used by major service providers. While these specifications offer a syntactic representation of the objects that the API uses, they may not provide a single conceptual model of all objects, their attributes and relations, and the logical organization of objects. Further, they tend to include definitions of many auxiliary objects made to facilitate the use of the API.

Having a conceptual data model of the resources available in the APIs of a service provider is useful when developing and debugging tools that interact with its services. However, such models are rarely available, and the information necessary to build them is often scattered among many unstructured textual documents. Further, constructing a conceptual model manually is a laborious, and error-prone task that is often infeasible due to the size and complexity of modern services. Even when a model is created, it can quickly become obsolete as the service evolves.

### SUMMARY

Implementations of the present disclosure are directed to systems and methods for a system that automatically generates ontologies from programmatic specifications such as application programming interface specifications. The disclosed techniques can be used to provide a single conceptual model of all API objects, object attributes and relations, and the logical organization of objects. The disclosed techniques can be used to refine ontologies by removing or combining auxiliary objects that facilitate the use of the API.

Some REST APIs are documented in OpenAPI specifications. These offer a syntactic representation of the objects that the APIs expose. However, they do not provide a unified and complete conceptual model that underlies the service. In this specification, a tool is presented for accelerating the construction of formal conceptual models from OpenAPI specifications. The tool extracts types from OpenAPI specifications, models them as a type graph, and runs a series of classification and refinement steps to infer a higher-level conceptual model, subject to predetermined modelling rules.

A conceptual model of the objects of service provider can be used to better organize and interoperate data that is collected by logging the API calls, or by querying the service provider. The disclosed techniques can be used to extract a formal model (e.g., an ontology) from a repository of programmatic specifications. The system crawls the repository, finds specifications, and extracts object definitions. Then, the system creates a representation of all objects found in the specifications and refines this representation according to pre-configured object classification and refinement procedures. Finally, the system constructs a formal ontology that reflects the conceptual model behind the service. The target schema is configurable, such that ontological concepts can be mined using non-standard schema.

In some implementations, actions include receiving data indicating a configuration for a data crawler; extracting, by the data crawler, representations of a subset of programmatic specifications; generating a knowledge graph model of the subset of the programmatic specifications; refining the knowledge graph model by classifying nodes in the knowledge graph model to obtain a refined knowledge graph model; and generating an ontology from the refined knowledge graph model.

Other implementations of this aspect include corresponding systems, apparatus, and computer programs, configured to perform the actions of the methods, encoded on computer storage devices.

These and other implementations can each optionally include one or more of the following features: the knowledge graph model includes nodes and edges; a first node represents a first object type; a second node represents a second object type; attributes of the first node represent attributes of the first object type; and an edge between the first node and a second node represents an attribute of the first object type that references the second object type; classifying the nodes in the knowledge graph model comprises classifying a node as matching a category; and refining the knowledge graph model comprises: in response to classifying the node as matching the category, applying a refinement policy for the category; applying the refinement policy for the category comprises removing the node from the knowledge graph model; applying the refinement policy for the category comprises collapsing the node into another node of the knowledge graph model; collapsing the node into the another node of the knowledge graph model comprises collapsing attributes of the node into the another node; collapsing the node into the another node of the knowledge graph model comprises connecting edges of the node to the another node; classifying the nodes in the knowledge graph model comprises evaluating the knowledge graph model using a set of classifiers, each classifier of the set of classifiers being associated with a type category; receiving policy data identifying the set of classifiers for evaluating the knowledge graph model; the policy data is received as user input; refining the knowledge graph model comprises: evaluating the knowledge graph model using a first classifier of the set of classifiers; based on the evaluation using the first classifier, removing nodes of the knowledge graph model to obtain a first refined knowledge graph model; evaluating the first refined knowledge graph model using a second classifier of the set of classifiers; and based on the evaluation using the second classifier, removing nodes of the knowledge graph model to obtain a second refined knowledge graph model; refining the knowledge graph model comprises: iteratively classifying nodes of the knowledge graph model and refining the knowledge graph model based on the classifications of the nodes to obtain the refined knowledge graph model; refining the knowledge graph model by: iteratively performing, on the knowledge graph model, a series of steps, each step including a classification sub-step and a refinement sub-step, until a similarity between a second refined knowledge graph model output by a final step of the series of steps and a first refined knowledge graph model output by the final step of the series of steps in the immediately previous iteration satisfies similarity criteria; and determining to generate the ontology from the second refined knowledge graph model; refining the knowledge graph model by: applying a set of classifiers and refiners to the knowledge graph model to obtain a first refined knowledge graph model; and determining that a similarity between the first refined knowledge graph model and the knowledge graph model satisfies similarity criteria; and in response to determining that the similarity between the first refined knowledge graph model and the knowledge graph model satisfies similarity criteria, determining to generate the ontology from the first refined knowledge graph model; the programmatic specifications comprise application programming interface (API) specifications; the programmatic specifications comprise databases of tables; presenting a visual representation of the ontology on a user interface; the data indicating the configuration for the data crawler is received as user input.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

The disclosed techniques can be implemented for enhancing cyber security of the cloud environment. Many cloud providers provide an API to create, update, or manipulate cloud resources. For example, a cloud-computing platform may expose REST APIs for many of its services. The APIs are documented and readily available in a public Git repository. Extracting a rich formal model from such repositories allows one to better interpret and enrich data that is extracted from the API directly, or from external tools that use that API to collect information about cloud resources.

As an example, the disclosed techniques can be used to query the cloud API and identify security findings in cloud resources. Using the ontology mined from a cloud-computing platform REST API, the system can extract all services, the services for which the collectors' reported findings, and the services for which the collectors did not report findings. By leveraging the extracted service to resources associations, the risk of each service can be computed with regards to the resources that are associated with the service.

Associating an application with its resources can improve the performance of application security analysis, the running of compliance checks, and the proposal of alternative deployment strategies. Mined ontologies can be stored in a catalog that includes many different services and their associated resources. The catalog can be used to organize the resources by services, provide textual descriptions of each resource, and restrict user selection to valid resources.

The disclosed techniques can result in at least the following technical advantages. Large numbers of files can be mined and modeled quickly and efficiently. A refined model can be generated from an initial model, with a reduction of up to twenty percent or more in the number of types between the initial model and the refined model. A reduction of up to forty percent or more can be achieved in the number of relations of the refined model compared to the initial graph. The reduced model improves processing time and reduces data storage requirements. The ontological model can be computed quickly, e.g., in as few as ten seconds or less. The ontological model can be computed automatically, e.g., in response to detecting a change to one or more programmatic specifications in a repository. As APIs evolve over time, the disclosed techniques can be used to obtain an up-to-date ontological model quickly, frequently, and without user input. For example, the most recent version of the public repository can be cloned, and the model can be extracted from the latest stable specifications of each service. The disclosed systems can be implemented to convert generate a knowledge graph model and to convert the model to a standardized language, e.g., web ontology language (OWL) ontology format. The techniques can be used to create ontologies from multiple sources. The standardize representations of multiple sources can facilitate the creation of a data-catalog that includes a conceptual representation of APIs, data models, and more. Given that the models are generated in the same standardized language, the models can be quickly searched. The models can be combined and used to efficiently create new data models.

The disclosed techniques can be used to perform model-based inference and validation. The extracted ontology includes assumptions about objects, their attributes, and their relations to other objects. This information can be leveraged to validate the correctness of the extracted data, or to automatically infer new insights from the data.

As an example of data validation, if the value of an attribute of an object is inconsistent with the ontology, this could be reported to the data provider. If the model specifies that a certain type of object has an attribute that takes a single value, then the system could automatically assign that value to all objects of that type (even of the attribute was not collected). A data validator tool can take an ontology and validate the correctness of input data. To ensure that the cloud security advisor is operating on valid data, the mined ontology can be used to validate data coming from external tools (and mapped to the corpus of the ontology) against the types and axioms in the ontology.

Access to a formal conceptual data model of the resources available in programming specification such as APIs of a service provider is of great value when building, troubleshooting or securing applications that interact with its services. Such a model can be used to validate the accuracy and completeness of implemented functionalities, to better identify dependencies between resources, to realize assumptions about resources and their properties, and to infer and enrich collected information. Further, a conceptual data model of resources available in programming specifications can be used in downstream tasks such as running queries to investigate the services, computing summary statistics, and populating user interfaces.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF THE DRAWINGS

FIG. 1 depicts an example architecture that can be used to execute implementations of the present disclosure.

FIG. 2 depicts an example system for generating ontologies in accordance with implementations of the present disclosure.

FIG. 3 depicts an example workflow manager of a system for generating ontologies in accordance with implementations of the present disclosure.

FIG. 4A shows an example initial knowledge graph in accordance with implementations of the present disclosure.

FIG. 4B shows an example refined knowledge graph in accordance with implementations of the present disclosure.

FIG. 5 is a flowchart of an example process that can be executed in accordance with implementations of the present disclosure.

Like reference numbers and designations in the various drawings indicate like elements.

### DETAILED DESCRIPTION

Implementations of the present disclosure are directed to systems and methods for a system that automatically generates ontologies from programmatic specifications such as application programming interface (API) specifications. Ontology mining includes multiple tasks, such as term extraction, synonym discovery, concept formation, concept hierarchy, relation discovery, and axioms extraction. The disclosed systems and methods can be used to automatically extract ontological information from programmatic specifications. The system includes classifier and refiner components, The classifier identifies whether an object is a class, or a property of another class according to its textual and contextual patterns. The refiner applies a model refinement policy according to the classification.

The systems can be used to extract ontologies from programmatic specifications such as representational state transfer (REST) APIs. The system can take a repository of Swagger/OpenAPI documents and apply a series of classification-to-refinement operations to produce a formal ontology that shows the objects that the API includes, their attributes, and their relations to other objects. As an example, the system can generate a model from specifications extracted from the cloud-computing platform REST APIs repository for use by a cloud security advisor. While the approach is generally described herein with reference to REST APIs, the disclosed techniques are applicable for other types of programmatic specifications. The disclosed techniques provide systems and methods to automatically mine ontological concepts from programmatic specifications. The ontological concepts can be automatically updated over time in order to maintain current, accurate information.

REST web services are used for creating stateless web services. The web service usage can be categorized as provider developers' and consumer developers. Provider developers develop APIs and publish along with Open API specification. Published web services are consumed by consumer developers. Consumer developers integrate third party web services in their solutions. OWL-S is the universal ontology specification to represent REST service semantics.

Ontology learning from text is a process that aims to automatically, or semi-automatically, extract and represent the knowledge from text in machine-readable form. Ontology is a way of representing the knowledge in a more meaningful way on the semantic web. Usage of ontologies has proven to be beneficial and efficient in different applications (e.g., information retrieval, information extraction, and question answering). Nevertheless, manually construction of ontologies is time-consuming as well extremely laborious and costly process.

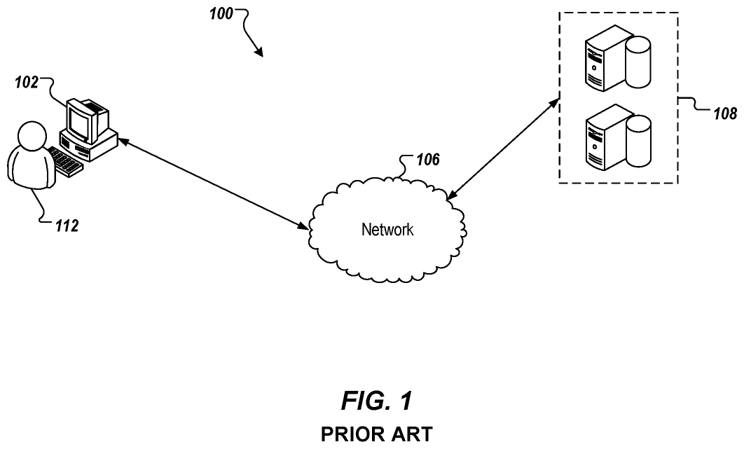

FIG. 1 depicts an example architecture 100 in accordance with implementations of the present disclosure. In the depicted example, the example architecture 100 includes a client device 102, a network 106, and a server system 108. The server system 108 includes one or more server devices and databases (e.g., processors, memory). In the depicted example, a user 112 interacts with the client device 102.

In some examples, the client device 102 can communicate with the server system 108 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 108 includes at least one server and at least one data store. In the example of FIG. 1, the server system 108 is intended to represent various forms of servers including, but not limited to a web server, an application server, a proxy server, a network server, and/or a server pool. In general, server systems accept requests for application services and provide such services to any number of client devices (e.g., the client device 102 over the network 106). In accordance with implementations of the present disclosure, and as noted above, the server system 108 can host a client development tool (CDT) platform.

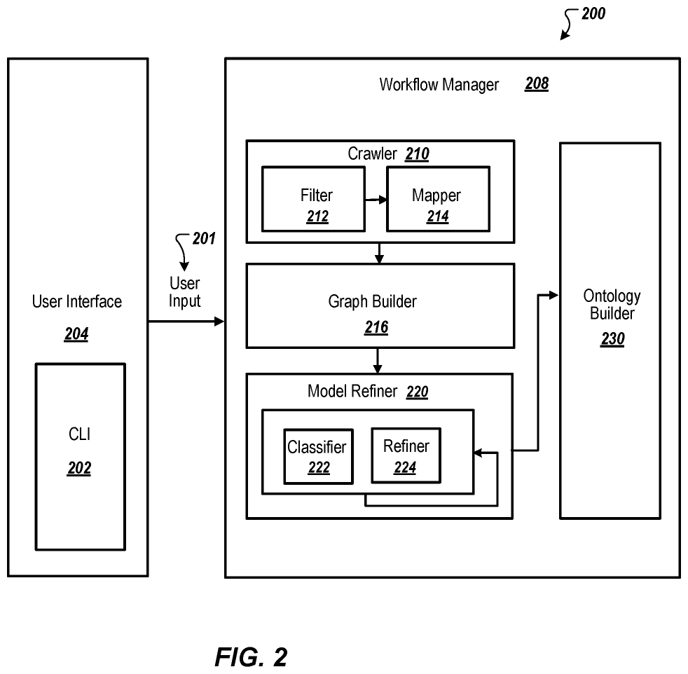

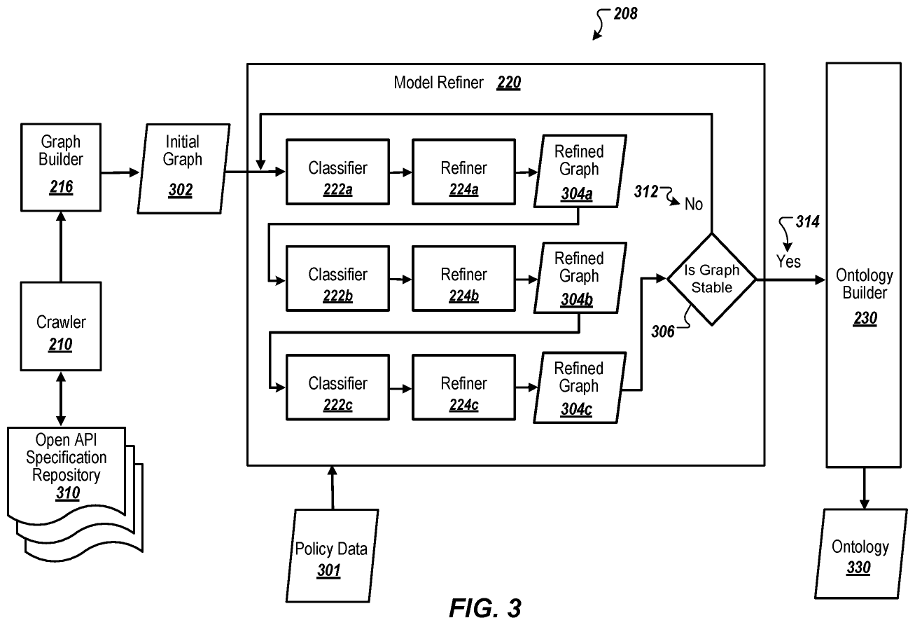

FIG. 2 depicts an example system 200 for generating ontologies in accordance with implementations of the present disclosure. The system includes a user interface (UI) 204 and a command line interface (CLI) 202. A CLI is a UI that is text-based. A CLI can be used to manage and view files. The system 200 includes a workflow manager 208. The workflow manager 208 manages a crawler 210, a graph builder 216, a model refiner 220, and an ontology builder 230. Operations of the workflow manager 208 are described in greater detail with reference to FIG. 3. The crawler 210 includes a filter 212 and a mapper 214. The model refiner 220 includes a set of classifiers 222 and a set of refiners 224.

In general, the crawler 210 scans a repository of programmatic specifications and loads and extracts object definitions from each specification. The graph builder 216 builds a knowledge graph representation of the objects. In some examples, the graph builder 216 is a types graph builder. The model refiner 220 applies a series of classification procedures to distinguish between conceptual objects that stand on their own to auxiliary objects, such as lists or properties of other objects. Then, the model refiner 220 applies refinement procedures to produce a finer representation. The ontology builder 230 builds a single ontology 330 that captures all conceptual objects that the API exposes, their attributes, their relations to other objects, and axioms that described them. The model is also enriched with textual descriptions for all the above taken from the specifications.

The crawler 210 crawls over the documents in the input path and pulls data from the documents. The crawler 210 includes a filter 212 that filters out irrelevant information from the collected data as determined by the configuration of the crawler 210. The configuration defines the crawling method performed by the crawler 210. For example, if a service includes multiple versions of an API, the crawler 210 can be configured to take the most recent version. The criteria can also indicate which specifications are out-of-the-scope for the analysis. The crawler 210 can recursively search the repository and extract files that fit the crawling criteria.

The crawler 210 includes a mapper 214 that maps definitions in the specifications to their ontological corresponding concepts. The concepts can include, for example, class, property, link, etc. After the files are collected, the crawler 210 parses each file and extracts definitions of the supported ontological information, such as object types and their attributes. The crawler 210 creates a standard representation of the extracted types. Each type is given a unique resource identifier (URI). References to a type are made by its URI. Each type can be encoded as a dictionary that includes its description, and its attributes. The attributes are encoded as a dictionary that maps attribute names to their type. The attribute type can be primitive, references to other objects, or arrays of the single types (primitive or objects). Attributes that hold arrays can be enriched with cardinality constraints that describe the minimal or maximal number of values that they can hold. In addition, inheritance relations within the specification can be encoded in the deriving type using the URI of the parent type(s).

Once all specifications are scanned, the graph builder 216 encodes the extracted types as an initial graph, e.g., a type graph. The graph builder 216 forms a graph, e.g., a type graph, that unifies the extracted types and stores their properties and relationships. In the initial graph, nodes can represent types, and edges can represent relations between the types.

The model refiner 220 takes the initial graph produced by the type graph builder 216 and runs a series of classification-refinement steps until a stable model is obtained. Each step includes a classification sub-step and a refinement sub-step. The model refiner 220 applies a series of classification and refinement procedures performed by the classifier 222 and the refiner 224 in order to refine the model reflected by the knowledge graph. In some examples, the model refiner 220 refines the graph based on user input 201. In some examples, the user input 201 can identify that a specific entity needs to be refined. In some examples, the user input 201 can indicate whether an entity is conceptual or not conceptual. In some examples, the set of classifiers 222 of the model refiner 220 identifies entities that are properties of other entities, and the set of refiners 224 collapses the entities to refine the graph. Thus, each classification is followed by a refinement procedure performed by the refiner 224. The model refiner 220 iterates all nodes in the graph, and refines the classified nodes by a pre-defined set of rules.

After the model refiner 220 applies all required classification-refinement operations, the ontology builder 230 builds an OWL ontology 330 that captures all conceptual objects that the API exposes, their attributes, their relations to other objects, and axioms that described them. The ontology builder 230 outputs an ontology 330 describing the services and assets provided by the cloud provider. The output ontology 330 is in OWL format and describes the data collected.

FIG. 3 depicts an example workflow manager 208 of the system 200 for generating ontologies in accordance with implementations of the present disclosure. The workflow manager 208 includes a crawler 210, a graph builder 216, a model refiner 220, and an ontology builder 230. The model refiner 220 includes classifiers 222a, 222b, 222c (“classifiers 222”) and refiners 224a, 224b, 224c (“refiners 224”).

The repository 310 includes programmatic specifications, e.g., OpenAPI specifications of REST API services published by a service provider and produces an OWL ontology of services and their resources. Systems are often an interplay of third-party web services. Developers in their role as requesters integrate existing services of different providers into new systems. Providers use frameworks like Open API to create syntactic service specifications from which requesters generate code to integrate services. Service discovery is crucial to identify usable services in the growing plethora of third-party services.

The crawler 210 scans the repository 310 and extracts definitions of data types and their properties. The repository 310 defines a standard, language-agnostic interface to REST APIs. An OpenAPI specification can include the following sections: openapi and info sections that hold metadata about the API; a servers section that includes connectivity information; a paths section that describes paths and operations of the API; a definitions section that holds definitions of data types used by the API; security mechanism, external documents, and more. The JavaScript Object Notation (JSON) Schema is an Internet Engineering Task Force (IETF) standard providing a format for what JSON data is required for a given application and how to interact with it. JSON schema objects include input and output data types. The types can be Booleans, Strings, Numbers, Nulls, Objects, and Arrays. The types can be used to specify requirements that a given JSON document must satisfy. In this specification, the terms schema object, object, and type are used interchangeably.

An example repository of programmatic specifications is a cloud-computing platform repository. The cloud-computing platform repository serves as the canonical source for REST API specifications for a cloud-computing platform, such as Microsoft Azure. The cloud-computing platform repository documents specifications of hundreds of services. The specifications of each service are documented in a separate folder and are split to specifications of the control plane and of the data plane. The repository includes previous and current versions of the specifications. In some examples, the crawler 210 can be configured to select the most recent stable version of each specification. In some examples, the most recent version of a specification references one or more older versions. In those examples, the crawler 210 also mines the referenced versions. In an example scenario, the crawler 210 extracts 415 specification files from 152 service folders, and extracts a total of 10,576 type definitions, and 32,839 properties.

The repository of programmatic specifications can include different types of specifications. In some examples, the repository of programmatic specifications includes one or more databases. A database can be built out of tables that have a structure, or schema. The system 200 can generate a graph that represents the databases. In some examples, a node of the graph represents a row of a table of a database. Relationships between rows of the tables can be represented by edges of the graph.

The workflow manager 208 transforms the tables of a database into a conceptual model and perform refinements. The refinements can include removing entities that are not conceptual and removing duplicate entities. The conceptual representation can represent entities such as accounts, transactions, and people from the tables of a database. The system 200 can generate an ontology that includes a conceptual representation of the databases. The ontology is a model that indicates the types of entities in the graph.

The crawler 210 takes, as input, a uniform resource locator (URL) or a path to a folder that includes programmatic specification documents. The crawler 210 also takes, as input, a configuration that includes criteria for which specification documents should be kept. In some examples, the crawler 210 receives user input indicating the configuration of the crawler 210.

The crawler 210 can be a specification crawler. The crawler 210 scans the Open API repository 310 and collects specifications that match search criteria. The crawler 210 iterates over each specification, extracts type definitions, normalizes the type definitions, and stores the type definitions in an intermediate data structure. The crawler 210 produces a dictionary that maps every service to its types. To this end, it first recursively traverses the root folder, and extracts specifications whose path matches search criteria. As different files may capture different versions of the same specification, the crawler 210 implements selection logic to identify the desired version.

When crawling a file, the crawler 210 first extracts meta-information about the file. This information includes the file's relative path (with respect to the root folder of the repository), and information under the OpenAPI info section, which is used to identify the service of the specification. Then, the crawler 210 extracts the definitions section, which includes definitions of schema objects, and puts the definitions in a dictionary that maps names to their schema objects. To ensure that schemas can be uniquely identified, and referenced properly, the crawler 210 follows the URI schema convention, and appends the path from the root folder to all schema names and to references.

After all files are scanned, the crawler 210 returns a dictionary per service that includes the definitions of the types. In some examples, the crawler 210 assumes that the types of a service provider can be partitioned into services. When such a partition does not exist, a dummy global service is added.

The crawler 210 outputs the API specifications to the graph builder 216. In some examples, each API specification includes a single file. The crawler 210 provides the files to the graph builder 216.

The graph builder 216 builds a knowledge graph representation of the object types. Each type is encoded as a node, and its primitive attributes are placed as node attributes. Attributes that reference other objects are encoded as labeled edges. The graph builder 216 outputs an initial graph structure generated from the normalized representation produced by the crawler 210. The graph structure represents the files of the mined API specifications.

The graph builder 216 gets the services' dictionaries from the crawler 210 and constructs the initial graph 302. The graph builder 216 encodes the extracted types as an initial graph 302, e.g., a type graph. The initial graph 302 unifies the extracted types and stores their properties and relationships. In the initial graph 302, nodes can represent types, and edges can represent relations between the types. The initial graph 400 is a labelled directed graph, which consists of service nodes and type nodes (representing schema objects). Each node has a name and a URI as extracted by the crawler. A type node has an outgoing edge to the service node it belongs to with an “of service” label.

The graph builder 216 encodes all keywords used to define a JSON schema object, except for properties, items, and allOf, as node attributes. These are represented differently due to their semantics. The Items keyword specifies an array type. If the array is of another schema object, the graph builder 216 encodes the array with an outgoing edge to the node representing the referenced type and label the edge “items”. Otherwise, the graph builder 216 encodes the array as a node attribute named “items” with the corresponding primitive type. The properties keyword is used to define named attributes. Attributes assigned to primitive types are encoded as node attributes. While attributes that reference schema objects (using ref keyword) are encoded as outgoing edges to the referenced object with the attribute name as a label. Lastly, the allOf keyword holds a reference to a schema object that states that the instances of the schema should validate against the referenced schema. The graph builder 216 encode this by an outgoing edge to the referenced node that the graph builder 216 labels “inherits.”

Once the initial graph 302 is formed, the graph is simplified by iteratively removing or collapsing nonconceptual data types from the type graph. To infer a conceptual data model from the type graph, the model refiner 220 runs a series of classifiers 222 to capture the nature of each type. To simplify the graph, the model refiner 220 scans the type graph nodes, classifies each according to its label, attributes and topology, and manipulates the graph accordingly using a series of refiners 224. In some examples, the model refiner 220 applies sets of classifiers 222 and refiners 224 according to policy, e.g., as defined by policy data 301. In some examples, the model refiner 220 applies sets of classifiers 222 and refiners 224 according to settings based on user input. In some examples, the policy data 301 is generated based on user input.

To automatically classify types, types classifiers perform textual and topological analysis of the nodes in the type graph. The types classifiers evaluate each node to determine if the node matches a category. To identify if a type matches a category, the type is analyzed with its neighbors, and the type is classified accordingly. If a type matches more than one category, it is refined according to the first matched category. Below are example classification rules used to classify cloud-computing platform types. Names of functional types are assumed to follow a simple prefix or suffix pattern, and contain terms that are indicative of the types' categories.

An example classification rule is that a node type matches a category if its label is an extension (prefix or suffix) of a category term. Another example classification rule is that a node type matches a category if its label is an extension (prefix or suffix) of a neighboring type (node), and the extension matches a category term.

Table 1 summarizes example refinement policies that can be used for functional type categories and lists example terms used to classify types. Different categories and policies can be used for different API and conceptual needs. Each category includes an example type, classification rules, examples of identifying terms, and a refinement policy. A Collection type is removed as the definition of the referenced type within the to-be constructed ontology reflects that there can be many instances of it. A Property type is collapsed into the type it describes. Results, Status and Operation types are removed, as they model interactions with the API.

TABLE 1

| Type | Examples | Rule | Terms | Policy |
|---|---|---|---|---|
| Collection | BillingMeterCollection | I | list, set | Remove |
| Properties | BlobContainerProperties | I | property, properties | Collapse |
| Results | QueryUtterancesResult | II | results, statistics | Remove |
| Operation | ResourceAvailabilityRequest | II | response, request | Remove |
| Status | ServerForUpdate | II | error | Remove |

The model refiner 220 initiates one classifier 222 per category, according to an extended set of the terms defined in Table 1. The model refiner 220 runs classifier 222a, 222b, 222c, with each being associated with a different type category. In an example, the classifier 222a is a “Collection” classifier, the classifier 222b is a “Properties” classifier, and the classifier 222c is a “Results” classifier. Although three classifiers 222 and three refiners 224 are shown in FIG. 3, more or fewer classifiers and refiners are possible.

Each classifier 222 iterates all nodes in the graph, and classifies each item in the graph to a pre-defined class. For example, the classifier 222a iterates all nodes in the initial graph 302. The classifier 222b iterates all nodes in the refined graph 304a, and the classifier 222c iterates all nodes of the refined graph 304c. If the model refiner 220 determines that the refined graph 304c is not stable 312, the classifier 222a iterates all nodes of the refined graph 304c in the next iteration.

The classifier 222 is a type classifier that uses a classification procedure to distinguish between conceptual objects that stand on their own and auxiliary objects that are defined in the API for usability purposes. The classifier 222 looks at the characteristics of a node type and classifies the node accordingly.

In some examples, a classifier 222 can include a collection classifier that parses the name of a node type and its body. The collection classifier can identify types that have a type name that ends with a word that is identified as a collection of objects (e.g., “List,” “Set”). The collection classifier can also identify types for which the body of the type has no primitive attributes; and types for which the node is connected to a single other node type. The collection classifier can classify node types that satisfy these criteria as collection type.

In some examples, a classifier 222 can include a properties classifier that parses the name of node type and its body. The properties classifier can identify types that have a type name that ends with the word “Properties.” The properties classifier can also identify types for which the node is connected to a single other node type. The properties classifier can classify node types that satisfy these criteria as properties type.

After running a classifier 222, the model refiner 220 runs a corresponding type refiner 224 that simplifies the graph accordingly. For example, after running the classifier 222a, the model refiner 220 runs the refiner 224a to obtain refined graph 304a. After running the classifier 222b, the model refiner 220 runs the refiner 224b to obtain refined graph 304b. After running the classifier 222c, the model refiner 220 runs the refiner 224c to obtain refined graph 304c. Thus, each classification performed by a classifier 222 is followed by a refinement procedure performed by the refiner 224. The model refiner 220 iterates all nodes in the graph, and refines the classified nodes by a pre-defined set of rules.

The refiner 224 is a type refiner that looks at the classification of a node type and manipulates it accordingly. The refiner 224 refines the model according to the nodes' classifications. For example, a refinement procedure can remove node of types that are classified as collections of objects of a single type. In some examples, the refiner 224 can include a node type remover. The node type remover can remove a node type and all of its edges. In some examples, the refiner 224 can include a node type folder. The node type folder takes a source node and a target node, and folds the target node into the source node. Node folding unifies the attribute of the target node into the source node. In the case that both nodes define an attribute, the source node attribute is kept. The edges of the target node are replaced with edges to the source node (except for an edge that connects the source and the target node). Finally, the target node and all its edges are removed. In some examples, the refiner 224 identifies nodes that should be edges, and replaces the nodes with edges.

In an example, from an ontological perspective, lists of types are often already captured by the specification of the type, since each type can be realized many times. Thus, by applying the collection classifier and then running the node type remover over the collection types, a better conceptual model can be obtained.

In another example, from an ontological perspective, properties of types do not stand on as concepts on their own and could be modelled as properties of a concept directly. Thus, by applying the properties classifier and then running the node type folder over the properties types, a better conceptual model can be obtained.

The model refiner 220 iteratively and repeatedly runs each of the classifiers 222 over the nodes, and refines the graph according to refinement policies established from the policy data 301. After running all classifiers 222 and refiners 224, the model refiner 220 checks if the graph is stable 306, e.g., if the graph changed in the last iteration. For example, the model refiner 220 determines if the refined graph 304c of a second iteration is different from the refined graph 304c of a first iteration. If the refined graph 304c has changed in the most recent iteration, the model refiner 220 determines that the graph is not stable 312. The model refiner 220 repeats the process of classification and refinement. If the refined graph 304c has not changed in the most recent iteration, the model refiner 220 determines that the graph is stable 314. The model refiner 220 outputs the refined graph 304c to the ontology builder 230.

The model refiner 220 iteratively performs sets of classification and refinement. The process is repeated until the graph is stable 314, e.g., until the graph does not change. In this way, the model refiner 220 takes the initial graph 302, and a specification of categories and classification-refinement policies (e.g., Table 1) and produces a refined graph 304c.

When the refined graph 304c is stable 314, the ontology builder 233 converts the stable refined graph 304c into a rich formal OWL ontology, which includes types, properties, descriptions, type hierarchies and constraints. The ontology builder 230 transforms the refined graph 304c, which is type graph, to an ontology 330 by expressing OpenAPI language constructs in OWL. In this way, the ontology builder 230 translates the refined graph 304 to a standard language.

Although OpenAPI and OWL have different purposes, they both support a formal definition of types, properties, relations, and constraints. A relation between types in both languages can take the form of associations (e.g., property of) or hierarchies (i.e., polymorphism). The OWL ontology is an ontology language for the Semantic Web with formally defined meaning. The OWL ontology can express classes, data properties, object properties, individuals (instances), primitive data types, and axioms e.g., sub-classof, cardinality and type constraints.

In some examples, each of the OpenAPI primitive types are mapped to the corresponding OWL 2 primitive. In some examples, an OWL class or an OWL data type is defined for each schema object that remains in the refined graph 304c. The name and internationalized resource identifier (IRI) of the type is set according to the node's label and URI. Metadata, such as title and description, is encoded using annotations. The encoding of schema objects to OWL depends on the schema type. If the type is Null, Number, String, or Boolean, then the schema is encoded as a new OWL datatype. Numerical and lexical restrictions (multipleOf, maximum, exclusiveMaximum, minimum, exclusiveMinimum maxLength, min-Length, pattern, enum) are encoded as OWL range restrictions.

Schemas of object or array types are encoded as OWL classes. For array types, an item's property is created. The property is defined as an object property if items references another type, and as a data property that is restricted to the relevant type otherwise (assuming that it is specified). Sub-classes of axioms are used to encode these. Restrictions over the size of the array, which are specified using minItems, maxItems are encoded using OWL min, max cardinality axioms resp. Metadata about properties is encoded using OWL annotations.

For object types, the named attributes are encoded in the properties field, as OWL properties. The same rules as in array types are used to encode the named attributes. Attributes that are defined as required are defined using some OWL restriction. Polymorphism is represented in OpenAPI by the allOf keyword, which references other schema object(s). This is encoded in OWL as a sub-class of axiom with respect to the referenced type(s). Some cardinality constructs (e.g., maxProperties) and advanced polymorphic concepts (e.g., oneOf) that cannot be expressed in OWL are encoded with class annotations. OpenAPI permits declaration of nested objects which cannot be expressed in OWL. In such cases, a string data type is used to encode the nested object.

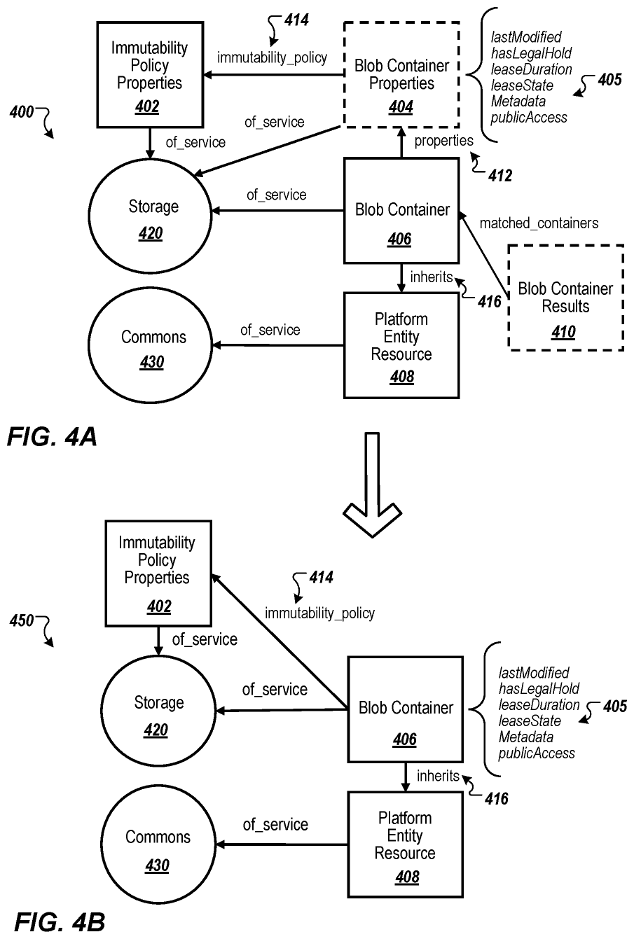

FIG. 4A shows a portion of an example initial knowledge graph 400. FIG. 4B shows a portion of an example refined knowledge graph 450. Referring to FIG. 4A, the graph 400 is a type graph that includes two nodes that represent services, shown as circular nodes 420, 430. The graph 400 includes five nodes that represent types, shown as rectangular nodes 402, 404, 406, 408. Example properties are encoded as node attributes or edges.

The graph 400 includes three types of the Storage 420 service, e.g., Immutability Policy Properties 402, Blob Container Properties 404, Blob Container 406. The graph 400 includes one type of the Commons service, e.g., Platform Entity Resource 408. The associations to services are represented by edges labeled “of service”. The Blob Container 406 has one referenced property to the Blob Container Properties 404, which is named “properties.” This is represented by an outgoing edge 412. The Blob Container Properties 404 type holds six primitive attributes 405, and one reference attribute to the Immutability Policy Properties 402. The Blob Container 406 schema includes an allOf keyword that references the Platform Entity Resource 408. This is represented by an “inherits” edge 406.

To infer a conceptual model from an API specification, the model refiner 220 separates conceptual types from functional types that are needed to interact with the service. An example policy is that, since functional types do not contribute conceptually, and they clutter the model, functional types are removed. Functional types can be defined and identified by following common, as well as, repository-specific, naming conventions. A collection category holds an array or a set of a single type. A properties category holds a property or properties of another type. A results category returns the results of a computation. An operation category performs an API operation. A status category reports a status of an API operation.

Per type category (Properties, Collection, Results, Operation, Status), the model refiner 220 scans all type nodes and runs the corresponding type classifier 222 and type refiner 224.

For example, the model refiner 220 can run the properties type classifier, which is a “Container Properties” type node configured with the following matching criteria: “node with a ‘properties’ or ‘property’ suffix that is referenced by a type of its prefix.” In this example, the Blob Container Properties 404 matches the Properties category, as its label ends with the “properties” suffix, and is an extension of the Blob Container 406. Thus, the Blob Container Properties 404 node is matched due to ending with the “properties” suffix and being connected to another type (Blob Container 406) with the same prefix. The model refiner 220 refines the graph 400 by

The model refiner 220 then runs the corresponding node-collapse type refiner 224, which collapses Blob Container Properties 404 into the Blob Container 406. The refiner 224 collapses the Blob Container Properties 404 into the Blob Container 406 by placing all its properties in the Blob Container 406, and connecting its edges to the Blob Container 406. For example, the refiner 224 puts all attributes 405 into the Blob Container 406 and reconnects edge 414 from the Blob Container 406 to the Immutability Policy Properties 402, as shown in FIG. 4B

The model refiner 220 then runs the type classifiers of the remaining categories (Results, Collection, Operations, and Status) with matching criteria: “node ends with a suffix from $TypeTerms,” where $TypeTerms denotes a set of matching strings defined per category. These type categories are configured with the node-remove type refiner, which removes matched nodes by deleting a matching node and all its edges.

In the example graph 400, the $TypeTerms of the Results category includes the term “Results,” so Blob Container Results 410 is matched to Blob Container 406. The model refiner 220 then runs the corresponding node-remove type refiner, which removes Blob Container Results 410 from the graph 400. Thus, the Blob Container Results 410 is not included in the refined graph 450.

No additional nodes are matched by the type classifiers of the Collection, Operations, and Status categories, so no further changes are made. As the graph changed in this model refinement iteration, the model refiner determines that the graph is not stable 312, and the model refiner 220 runs all type classifiers 222 and refiners 224 again. In the next iteration, no additional nodes are matched or changed, so the model refiner 220 determines that the graph is stable 314 and outputs the refined graph 450 to the ontology builder 230.

The model refiner 220 can be used to distinguish conceptual from functional types in the cloud-computing platform and to accurately classify them into categories. The disclosed techniques can be used to reduce the size of the initial model and to efficiently compute the model. In an example scenario, the ontology inferred by the workflow manager 208 includes a total of 8,407 out of 10,567 types and datatypes and 17,577 out of 32,839 relations. This reflects a reduction of 20.05% in the number of types, and 46.48% in the number of relations of the refined stable graph in comparison to the initial graph. In some examples, an average running time of the workflow manager 208 is ten seconds or less.

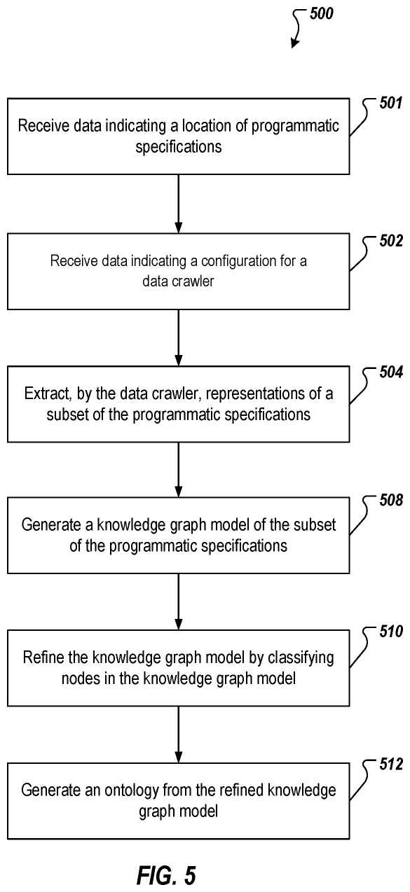

FIG. 5 is a flowchart of an example process 500 that can be executed in accordance with implementations of the present disclosure. In some implementations, the example process 500 may be performed using one or more computer-executable programs executed using one or more computing devices.

The process 500 includes receiving data indicating a location of programmatic specifications (501). For example, the system 200 can receive data indicating a location of a repository of API specifications or of database specifications that are to be modeled.

The process 500 includes receiving data indicating a configuration for a data crawler (502). For example, the system 200 can receive data indicating the configuration for the crawler 210. The data indicating the configuration can include data mining criteria for the crawler 210.

The process 500 includes extracting, by the data crawler, representations of a subset of the programmatic specifications (504). For example, the crawler 210 can extract, from the Open API Specification Repository 130, representations of a subset of the files of the repository 130. The crawler 210 can extract the subset of the files using criteria defined by the configuration data for the crawler 210.

The process 500 includes generating a knowledge graph model of the subset of the programmatic specifications (508). For example, the graph builder 216 can generate the initial graph 302 of the subset of programmatic specifications 508 extracted by the crawler 210.

The process 500 includes refining the knowledge graph model by classifying types of nodes in the knowledge graph (510). For example, the model refiner 220 refines the initial graph 302. In some examples, the model refiner 220 iteratively classifies nodes of the initial graph 302 and refines the initial graph 302 based on the classifications of the nodes to obtain the refined graph 304c.

In some examples, the model refiner 220 refines the initial graph 302 by iteratively performing a series of steps. Each step including a classification sub-step performed by a classifier 222 and a refinement sub-step performed by a refiner 224. In the example of FIG. 3, the series of steps includes: a first step, including a first classification sub-step performed by classifier 222a and a first refinement sub-step performed by refiner 224a, a second step, including a second classification sub-step performed by classifier 222b and a second refinement sub-step performed by refiner 224b, and a third step, including a third classification sub-step performed by classifier 222c and a third refinement sub-step performed by refiner 224c. The model refiner 220 performs the series of steps until a similarity between the refined knowledge graph model output by the final step of the series of steps (e.g., refined graph 304c output by the refiner 224c) and the knowledge graph model output by the final step of the series of steps in the previous iteration (e.g., the refined graph 304c output by the refiner 224c in the previous iteration) satisfies similarity criteria. In response to determining that the similarity satisfies similarity criteria, the model refiner 220 determines that the refined graph 304c is stable 314. In response, the model refiner 220 determines to generate the ontology 330 from the refined knowledge graph model, e.g., stable refined graph 304c.

The process 500 includes generating an ontology from the refined knowledge graph model (512). For example, the ontology builder 230 generates the ontology 330 from the stable refined graph 304c.

The process 500 can repeat by the system 200 going over the repository 310 and building another conceptual model. The repository 310 can include many files, e.g., thousands of files, that change frequently. In some examples, files of the repository 310 change on an hourly or daily basis. In some examples, the system 200 performs the process 500 at designated intervals, e.g., once per hour, once per day.

In some examples, the system 200 performs the process 500 when files of the repository 310 change. For example, the system 200 can monitor for changes in files of the repository 310. A change can be, for example, an addition or removal of a file of the repository 310. A change can be an update to one or more files of the repository 310. In some examples, the system 200 receives data indicating that a change occurred in the repository 310, and in response, performs the process 500. In this way, the ontology 330 is maintained current and up-to-date with the latest version of files in the repository 310.

In some examples, security applications can read the conceptual model, e.g., ontology 330. In some examples, a security application can use the model to present information on a dashboard. In some examples, the dashboard is presented on the user interface 204. The dashboard can present a conceptual model of files of the repository 310.

The system 200 assumes the programmatic specifications includes definitions of types of objects. The system 200 assumes that each type is only defined once, and that each type has a unique identifier (URI). The system 200 assumes that the attributes of a type are unique, such that a type cannot have two attributes with the same name. An attribute type can be primitive (e.g., string, number, date, int, as supported in OWL), or a reference to another object. When an object type references another object type, the system 200 assumes that the reference is done via the referenced type URI. Attributes can also be lists of primitive types or references to objects. Nested attributes such as attributes of type dictionary are treated as anonymous types, which are added to the model using automatically generated URI, with automatically assigned name. The system 200 supports various ontological information including types, polymorphism, definition of attributes via sub-class of axioms, enums, and cardinality restrictions.

For a model to be type complete, the system 200 assumes that all objects, their attributes and relations to other objects are available in the programmatic specifications. For completeness with regards to data validation and inference, the system 200 assumes that for each attribute the type is specified, and that cardinality constraints and inheritance is fully specified. For complete textual description, the specifications include a description of all types and attributes.

The system 200 can be used to accelerate the model construction process by automatically inferring a data model that can serve as a basis for further improvements. The immediate implication is the ability to infer, refine, and experiment with conceptual models of large service providers, and ensure consistency as the services evolve.

The system 200 includes several components that can be adapted to different service providers and according to the intent for using the conceptual model. As conceptual modelling is an iterative and cyclic process, users (ontologists, domain-experts, and data engineers) can examine the specifications and the resulting ontology 330, and provide user input 201 to adjust type categories, classifiers, and refiners until a desired model is achieved.

The categories can be examined and adjusted on a case-by-case basis. Similarly, the classifiers and refiners presented can be updated or replaced. Users can define new categories in a dedicated configuration file. A user can assign a classifier and refiner per category, and specify an execution order for the categories. New classifiers and refiners that operate over the type graph can be developed by inheriting from an abstract classifier and an abstract refiner class.

Implementations and all of the functional operations described in this specification may be realized in digital electronic circuitry, or in computer software, firmware, or hardware, including the structures disclosed in this specification and their structural equivalents, or in combinations of one or more of them. Implementations may be realized as one or more computer program products, i.e., one or more modules of computer program instructions encoded on a computer readable medium for execution by, or to control the operation of, data processing apparatus. The computer readable medium may be a machine-readable storage device, a machine-readable storage substrate, a memory device, a composition of matter effecting a machine-readable propagated signal, or a combination of one or more of them. The term “computing system” encompasses all apparatus, devices, and machines for processing data, including by way of example a programmable processor, a computer, or multiple processors or computers. The apparatus may include, in addition to hardware, code that creates an execution environment for the computer program in question (e.g., code) that constitutes processor firmware, a protocol stack, a database management system, an operating system, or a combination of one or more of them. A propagated signal is an artificially generated signal (e.g., a machine-generated electrical, optical, or electromagnetic signal) that is generated to encode information for transmission to suitable receiver apparatus.

A computer program (also known as a program, software, software application, script, or code) may be written in any appropriate form of programming language, including compiled or interpreted languages, and it may be deployed in any appropriate form, including as a stand-alone program or as a module, component, subroutine, or other unit suitable for use in a computing environment. A computer program does not necessarily correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program may be deployed to be executed on one computer or on multiple computers that are located at one site or distributed across multiple sites and interconnected by a communication network.

The processes and logic flows described in this specification may be performed by one or more programmable processors executing one or more computer programs to perform functions by operating on input data and generating output. The processes and logic flows may also be performed by, and apparatus may also be implemented as, special purpose logic circuitry (e.g., an FPGA (field programmable gate array) or an ASIC (application specific integrated circuit)).

Processors suitable for the execution of a computer program include, by way of example, both general and special purpose microprocessors, and any one or more processors of any appropriate kind of digital computer. Generally, a processor will receive instructions and data from a read only memory or a random access memory or both. Elements of a computer can include a processor for performing instructions and one or more memory devices for storing instructions and data. Generally, a computer will also include, or be operatively coupled to receive data from or transfer data to, or both, one or more mass storage devices for storing data (e.g., magnetic, magneto optical disks, or optical disks). However, a computer need not have such devices. Moreover, a computer may be embedded in another device (e.g., a mobile telephone, a personal digital assistant (PDA), a mobile audio player, a Global Positioning System (GPS) receiver). Computer readable media suitable for storing computer program instructions and data include all forms of non-volatile memory, media and memory devices, including by way of example semiconductor memory devices (e.g., EPROM, EEPROM, and flash memory devices); magnetic disks (e.g., internal hard disks or removable disks); magneto optical disks; and CD ROM and DVD-ROM disks. The processor and the memory may be supplemented by, or incorporated in, special purpose logic circuitry.

To provide for interaction with a user, implementations may be realized on a computer having a display device (e.g., a CRT (cathode ray tube), LCD (liquid crystal display), LED (light-emitting diode) monitor, for displaying information to the user and a keyboard and a pointing device (e.g., a mouse or a trackball), by which the user may provide input to the computer. Other kinds of devices may be used to provide for interaction with a user as well; for example, feedback provided to the user may be any appropriate form of sensory feedback (e.g., visual feedback, auditory feedback, or tactile feedback); and input from the user may be received in any appropriate form, including acoustic, speech, or tactile input.

Implementations may be realized in a computing system that includes a back end component (e.g., as a data server), or that includes a middleware component (e.g., an application server), or that includes a front end component (e.g., a client computer having a graphical user interface or a Web browser through which a user may interact with an implementation), or any appropriate combination of one or more such back end, middleware, or front end components. The components of the system may be interconnected by any appropriate form or medium of digital data communication (e.g., a communication network). Examples of communication networks include a local area network (“LAN”) and a wide area network (“WAN”) (e.g., the Internet).

The computing system may include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular implementations. Certain features that are described in this specification in the context of separate implementations may also be implemented in combination in a single implementation. Conversely, various features that are described in the context of a single implementation may also be implemented in multiple implementations separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

A number of implementations have been described. Nevertheless, it will be understood that various modifications may be made without departing from the spirit and scope of the disclosure. For example, various forms of the flows shown above may be used, with steps re-ordered, added, or removed. Accordingly, other implementations are within the scope of the following claims. The appendix included with this disclosure provides additional, alternative, and/or further elaborative examples of the systems and methods described herein and is part of this specification.

What is claimed is:

1. A computer-implemented method comprising:
receiving data indicating a configuration for a data crawler;
extracting, by the data crawler, representations of a subset of programmatic specifications;
generating a knowledge graph model of the subset of the programmatic specifications;
refining the knowledge graph model by classifying nodes in the knowledge graph model to obtain a refined knowledge graph model; and
generating an ontology from the refined knowledge graph model.

2. The method of claim 1, wherein:
the knowledge graph model includes nodes and edges;
a first node represents a first object type;
a second node represents a second object type;
attributes of the first node represent attributes of the first object type; and
an edge between the first node and a second node represents an attribute of the first object type that references the second object type.

3. The method of claim 1, wherein:
classifying the nodes in the knowledge graph model comprises classifying a node as matching a category; and
refining the knowledge graph model comprises:
in response to classifying the node as matching the category, applying a refinement policy for the category.

4. The method of claim 3, wherein applying the refinement policy for the category comprises removing the node from the knowledge graph model.

5. The method of claim 3, wherein applying the refinement policy for the category comprises collapsing the node into another node of the knowledge graph model.

6. The method of claim 5, wherein collapsing the node into the another node of the knowledge graph model comprises collapsing attributes of the node into the another node.

7. The method of claim 5, wherein collapsing the node into the another node of the knowledge graph model comprises connecting edges of the node to the another node.

8. The method of claim 1, wherein classifying the nodes in the knowledge graph model comprises evaluating the knowledge graph model using a set of classifiers, each classifier of the set of classifiers being associated with a type category.

9. The method of claim 8, comprising:
receiving policy data identifying the set of classifiers for evaluating the knowledge graph model.

10. The method of claim 9, wherein the policy data is received as user input.

11. The method of claim 8, wherein refining the knowledge graph model comprises:
evaluating the knowledge graph model using a first classifier of the set of classifiers;
based on the evaluation using the first classifier, removing nodes of the knowledge graph model to obtain a first refined knowledge graph model;
evaluating the first refined knowledge graph model using a second classifier of the set of classifiers; and
based on the evaluation using the second classifier, removing nodes of the knowledge graph model to obtain a second refined knowledge graph model.

12. The method of claim 1, wherein refining the knowledge graph model comprises:
iteratively classifying nodes of the knowledge graph model and refining the knowledge graph model based on the classifications of the nodes to obtain the refined knowledge graph model.

13. The method of claim 1, comprising:
refining the knowledge graph model by:
iteratively performing, on the knowledge graph model, a series of steps, each step including a classification sub-step and a refinement sub-step, until a similarity between a second refined knowledge graph model output by a final step of the series of steps and a first refined knowledge graph model output by the final step of the series of steps in the immediately previous iteration satisfies similarity criteria; and
determining to generate the ontology from the second refined knowledge graph model.

14. The method of claim 1, comprising:
refining the knowledge graph model by:
applying a set of classifiers and refiners to the knowledge graph model to obtain a first refined knowledge graph model; and
determining that a similarity between the first refined knowledge graph model and the knowledge graph model satisfies similarity criteria; and
in response to determining that the similarity between the first refined knowledge graph model and the knowledge graph model satisfies similarity criteria, determining to generate the ontology from the first refined knowledge graph model.

15. The method of claim 1, wherein the programmatic specifications comprise application programming interface (API) specifications.

16. The method of claim 1, wherein the programmatic specifications comprise databases of tables.

17. The method of claim 1, comprising presenting a visual representation of the ontology on a user interface.

18. The method of claim 1, wherein the data indicating the configuration for the data crawler is received as user input.

19. A non-transitory computer-readable storage medium coupled to one or more processors and having instructions stored thereon which, when executed by the one or more processors, cause the one or more processors to perform operations comprising:
receiving data indicating a configuration for a data crawler;
extracting, by the data crawler, representations of a subset of programmatic specifications;
generating a knowledge graph model of the subset of the programmatic specifications;
refining the knowledge graph model by classifying nodes in the knowledge graph model to obtain a refined knowledge graph model; and
generating an ontology from the refined knowledge graph model.

20. A system, comprising:
a computing device; and
a computer-readable storage device coupled to the computing device and having instructions stored thereon which, when executed by the computing device, cause the computing device to perform operations comprising:
receiving data indicating a configuration for a data crawler;
extracting, by the data crawler, representations of a subset of programmatic specifications;
generating a knowledge graph model of the subset of the programmatic specifications;
refining the knowledge graph model by classifying nodes in the knowledge graph model to obtain a refined knowledge graph model; and
generating an ontology from the refined knowledge graph model.
